(19) United States
(12) Patent Application Publication
(10) Pub. No.: US 2008/0057856 A1
(43) Pub. Date: Mar. 6, 2008

(54) Satellite Radio Media Download

(76) Inventor: Michael Jonathan Szanto, Chicago, IL (US)

Correspondence Address: Michael J. Szanto, 1730 N. Clark #1705, Chicago, IL, 60614, US

(21) Appl. No.: 11/468,776

(22) Filed: Aug. 31, 2006

(51) Int. Cl. H04H 1/00; H04H 20/74

(52) U.S. Cl. 455/3.02

(57) ABSTRACT

This process allows Satellite Radio Customers to download video, sound, or a combination with the use of a cell phone or a wimax enabled device.

### BACKGROUND OF THE INVENTION

Satellite radio has become a widely used medium for receiving sound and data on a variety of devices including mobile ones like car radios. However, satellite radio only allows for one way transmission of digital data, and there can be a need for interactive service. Additionally, receiving movies or audio/video clips have already become common on services like high speed internet and cable t.v. Currently, there are two satellite radio services in the United States—XM Satellite Radio and Sirius. A number of companies are providing or have plans to provide satellite radio service outside the United States. In the United States, satellite radio also transmits data that includes weather and traffic as well as text messages advertising phone numbers.

### BRIEF SUMMARY OF THE INVENTION

This method will allow users to download video, audio, or a combination advertised by transmitting a text message to a satellite radio by giving the users the opportunity to use a cell phone or a wimax enabled device to download it.

### DETAILED DESCRIPTION OF THE INVENTION

Satellite Radio Service will transmit text data alerting listener to available media and its URL address or IP number. User will then enter the URL into the cell phone or wimax enabled device. Access to the URL address or IP number can be restricted to proprietary cellular or wimax network. The server will then identify the user—either through a login or by the user's network address—accessing the downloaded media and bill his/her account. This process will allow manufacturers to provide for connecting a Satellite Radio to a wimax enabled device or cell phone so that users will not have to manually enter the URL to receive the content. The Satellite Radio Service will also be able to use this method for advertising other types of addresses for media that might be used by various cellular or wimax networks in addition to URL or IP addresses. The address of the available downloadable media will be transmitted with a special code, so that the satellite receiver is able to treat the information appropriately and as desired by the manufacturer of the receiver.

I claim:

1. The satellite radio broadcaster broadcasts the URL or IP address that can be displayed as text on a receiver so that users will be able to enter it into a cell phone or wimax enabled device to download any media.

2. The satellite radio broadcaster transmits any other type of address that users can enter into a cellphone or wimax enabled device to download any type of media.

3. Manufacturers of satellite radio receivers can link the satellite radio receivers to a cellphone or wimax enabled device to allow user to download any media.
